(19) United States
(12) Patent Application Publication
(10) Pub. No.: US 2018/0157964 A1
(43) Pub. Date: Jun. 7, 2018

(54) HIGH-DENSITY NEURAL NETWORK ARRAY

(71) Applicants: Fu-Chang Hsu, San Jose, CA (US); Kevin Hsu, San Jose, CA (US)

(72) Inventors: Fu-Chang Hsu, San Jose, CA (US); Kevin Hsu, San Jose, CA (US)

(21) Appl. No.: 15/821,679

(22) Filed: Nov. 22, 2017

Related U.S. Application Data
(60) Provisional application No. 62/430,341, filed on Dec. 5, 2016.

(51) Int. Cl. G06N 3/04; G06N 3/063

(52) U.S. Cl. CPC G06N 3/04; G06N 3/063

(57) ABSTRACT

A high-density neural network array. In an exemplary embodiment, an apparatus includes a three-dimensional (3D) structure having a plurality of layers forming a neural network. Each layer comprises one or more conductors forming neurons with each neuron having neuron inputs and neuron outputs. The apparatus also includes synapse elements coupled between the neurons outputs and the neuron inputs of neurons in adjacent layers. Each synapse element comprises a material that applies a selected weight to signals passing between neurons connected to that synapse element.

### PRIORITY

This application claims the benefit of priority based upon U.S. Provisional Patent Application having Application No. 62/430,341, filed on Dec. 5, 2016, and entitled “NOVEL HIGH-DENSITY 3D NEURAL NETWORK ARRAY,” which is hereby incorporated herein by reference in its entirety.

### FIELD OF THE INVENTION

The exemplary embodiments of the present invention relate generally to the field of semiconductors, and more specifically to neural network arrays.

### BACKGROUND OF THE INVENTION

A neural network is an artificial intelligence (AI) system that has learning capabilities. AI systems have been used for may applications such as voice recognition, pattern recognition, and hand-writing recognition to name a few.

The typical neural network may be implemented by using software or hardware. A software implementation of a neutral network relies on a high-performance CPU to execute specific algorithms. For very high density neural networks, the speed of the CPU may become a bottleneck to the performance of real-time tasks. On the other hand, the hardware implementation is more suitable for high-speed real-time applications. However, typical circuit sizes may limit the density or size of the neuron network thereby limiting its functionality.

Therefore, it is desirable to have a high-density neural network that overcomes the problems associated with conventional networks.

### SUMMARY

A novel high-density three-dimensional (3D) neutral network array structure is disclosed. In various exemplary embodiment, the 3D neural network array provides much higher density and speed over conventional neural networks.

In an exemplary embodiment, an apparatus is provided that includes a three-dimensional (3D) structure having a plurality of layers forming a neural network. Each layer comprises one or more conductors forming neurons with each neuron having neuron inputs and neuron outputs. The apparatus also includes synapse elements coupled between the neurons outputs and the neuron inputs of neurons in adjacent layers. Each synapse element comprises a material that applies a selected weight to signals passing between neurons connected to that synapse element.

In an exemplary embodiment, a three-dimensional (3D) neural network structure is provided that includes an input layer having at least one input conductor forming an input neuron, one or more hidden layers, each hidden layer having at least one hidden conductor forming hidden neurons, and an output layer having at least one output conductor forming an output neuron. The apparatus also includes threshold material coupled to each of the input, hidden, and output conductors, and synapse elements coupled between the threshold material associated with a selected layer and the conductors of an adjacent layer. Each synapse element comprises a material that applies a selected weight to signals passing through that synapse element.

In an exemplary embodiment, a method is provided for programming a three-dimensional (3D) structure having a plurality of layers forming a neural network. Each layer comprises one or more conductors forming neurons, and synapse elements are coupled between neurons of adjacent layers. The method includes applying input voltages to an input layer of the neural network, measuring output voltages at an output layer of the neural network, determining an error value as a function of the input voltages and the output voltages, and adjusting weights associated with the synapse elements if the error value is greater than an error threshold.

Additional features and benefits of the exemplary embodiments of the present invention will become apparent from the detailed description, figures and claims set forth below.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1A shows an exemplary embodiment of a neural network structure;

FIG. 1B shows an exemplary embodiment of a neuron and its associated functions;

FIG. 1C shows an exemplary embodiment of a synapse and its associated functions;

FIG. 2 shows an exemplary embodiment of a three-dimensional (3D) neural network structure;

FIG. 3 shows an exemplary embodiment of a circuit that is representative of the 3D neural network structure shown in FIG. 2;

FIG. 4 shows an exemplary embodiment of a circuit that is representative of the 3D neural network structure shown in FIG. 2 and includes an exemplary embodiment of a reference circuit;

FIG. 4A shows an exemplary embodiment of the 3D neural network structure shown in FIG. 2 and further coupled to a first biasing structure;

FIG. 4B shows an exemplary embodiment of a 3D neural network structure shown in FIG. 2 and further coupled to a second biasing structure;

FIG. 5A shows a detailed exemplary embodiment of the reference circuit shown in FIG. 4;

FIG. 5B shows another detailed exemplary embodiment of a reference circuit shown in FIG. 4;

FIG. 6 shows an exemplary embodiment of a programming circuit that programs the resistive elements of the 3D neural network structure;

FIG. 7 shows another exemplary embodiment of partitioning one or more layers into two or more groups;

FIG. 8 shows an exemplary embodiment of method for programming a 3D neural network structure; and

FIG. 9 shows an exemplary embodiment of method for operating a 3D neural network structure.

### DETAILED DESCRIPTION

Those of ordinary skilled in the art will realize that the following detailed description is illustrative only and is not intended to be in any way limiting. Other embodiments of the present invention will readily suggest themselves to skilled persons having the benefit of this disclosure. Reference will now be made in detail to implementations of the exemplary embodiments of the present invention as illustrated in the accompanying drawings. The same reference indicators or numbers will be used throughout the drawings and the following detailed description to refer to the same or like parts.

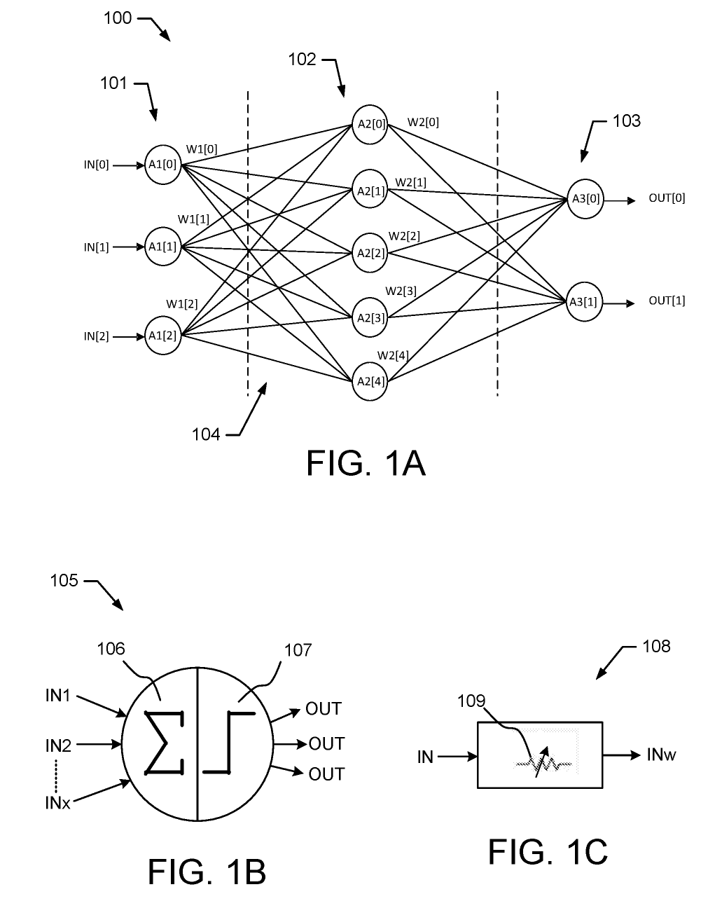

FIG. 1A shows an exemplary embodiment of a neural network structure 100. The neural network structure 100 comprises three layers. The first layer is an input layer 101 that includes three input neurons (A1[0]-A1[2]). A second layer is a hidden layer 102 that includes five neurons (A2[0]-A2[4]). A third layer is an output layer 103 that includes two neurons (A3[0]-A3[1]). In other embodiments, the neural network structure 100 may contain more than one hidden layer, and any number of neurons in each layer. With more layers and more neurons, the neural network structure 100 can learn more complicated tasks.

The neurons of the different layers are connected through synapses 104 that transfer signals between the neurons. Each synapse applies a variable ‘weight’ to the signal flowing through it. For example, the synapse connecting neurons A1[0] and A2[0] provides weight W1[0] to the signal flowing through it, and the synapse connecting neurons A1[1] and A2[0] provides weight W1[1] to the signal flowing through it, respectively. As illustrated in FIG. 1A, the synapses connecting the input layer 101 to the hidden layer 102 provide variable weights W1[x], and the synapses connecting the hidden layer 102 to the output layer 103 provide variable weights W2[x].

During operation, input signals IN(0-2) flow into the input layer of neurons 101 and then flow through one or more hidden layers of neurons, such as hidden layer 102, and finally flow to the output layer of neurons 103. By adjusting the weights of the synapses it is possible to “train” the neural network 100 to generate a desired set of outputs (OUT(0-1) given a particular set of inputs (IN(0-2)).

FIG. 1B shows an exemplary embodiment of a neuron 105 and its associated functions. For example, the neuron 105 is suitable for use as any of the neurons shown in FIG. 1A. The neuron 105 provides two functions. The first function is a summation function 106, and the second function is a threshold function 107. The summation function 106 determines the sum of input signals (e.g., IN1-INx) that are received by the neuron. The threshold function 107 determines whether the sum exceeds a threshold value. If the sum exceeds the threshold value, the neuron generates one or more output signals (OUT) having a particular output value. For example, for the neuron A2[0] shown in FIG. 1A, the sum of its input signals can be determined from the following expression.

A2[0]=(IN[0]×W1[0])+(IN[1]×W1[1])+(IN[2]×W1[2]) (Eq. 1)

Similarly, for the neuron A3[0] shown in FIG. 1A, the sum of its input signals can be determined from the following expression.

A3[0]=(A2[0]×W2[0])+(A2[1]×W2[1])+(A2[2]×W2[2])+(A2[3]×W2[3])+(A2[4]×W2[4]) (Eq. 2)

For each neuron, the sum of its inputs is passed to its threshold function (e.g., 107). When the sum of the inputs is higher than the threshold, the threshold function will generate an output signal to the neuron's output(s). Otherwise, there is no output from the neuron. For example, when the sum of the inputs is higher than the threshold, the neuron may generate a signal of logic 1 to the output. When the sum is lower than the threshold, the neuron may generate a signal of logic 0 to the output. In a hardware implementation, logic 1 may be VDD and logic 0 may be 0V. This mechanism is also known as ‘winner takes all’.

FIG. 1C shows an exemplary embodiment of a synapse element 108 and its associated function. For example, the synapse element 108 is suitable for use as any of the synapses 104 shown in FIG. 1A. The synapse element 108 comprises a variable weighting function 109 that applies a variable weight to a signal received at the synapse input to generate a weighted signal (INw) at the output of the synapse element. In an exemplary embodiment, the variable weighting function 109 provides either a continuous weighting function or variable weighting in discrete steps. For example, in an exemplary embodiment, the variable weighting function provides variable weighting in 8 steps. For example, in an exemplary embodiment, the variable weighting function provides variable weighting in 8 steps, such as 1K ohm, 5K ohm, 10K ohm, 50K ohm, 100K ohm, 500K ohm, 1M ohm, 5M ohm. A more detailed description of the how the variable weighting function operates is provided below.

The learning process for a neural network (e.g., the network 100) includes two steps. The first step is called forward-propagation, which calculates an output of the network based on the inputs and the existing weights of the synapses. After that, the output is compared to a desired output to obtain an error value. The second step is called backward-propagation and is used to adjust the weights of the synapses according to the error value. The purpose of the adjustment of the weights of the synapses is to reduce the error value. These two steps are alternatively repeated many times to gradually reduce the error value until the error value is smaller than a predetermined error threshold. At that point, the learning or “training process” is complete. The final weights stored in the synapses represents the learning result. The neural network then can be used for applications such as pattern recognition. When the inputs are presented, the neural network performs forward-propagation with the stored weights to generate the desired output.

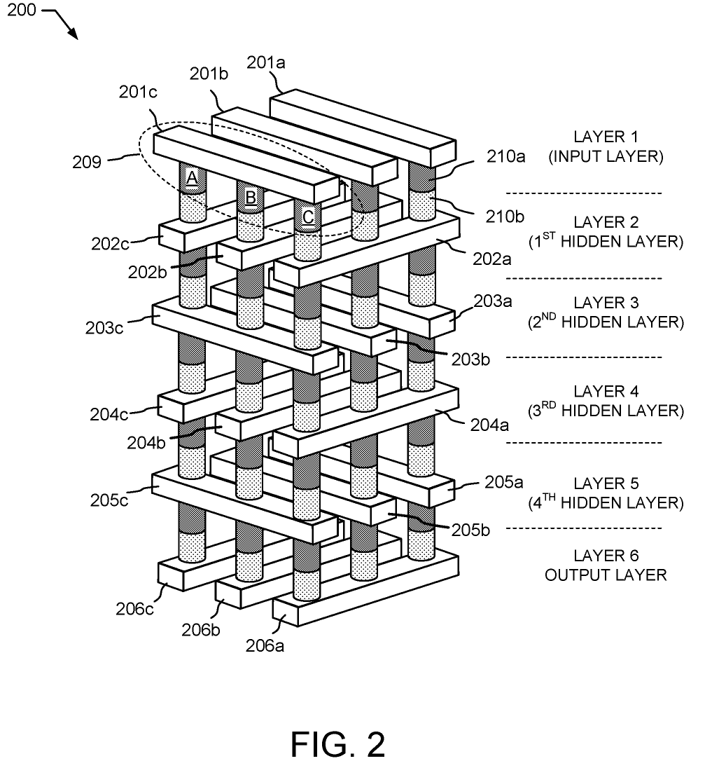

FIG. 2 shows an exemplary embodiment of a three-dimensional (3D) neural network structure 200. The structure 200 comprises a first layer having conductors 201a-c. For example, the conductors may comprise metal or another suitable conductor material. In an exemplary embodiment, the first layer functions as the input layer 101. The structure 200 also comprises a second layer having conductors 202a-c, a third layer having conductors 203a-c, a fourth layer having conductors 204a-c, and a fifth layer having conductors 205a-c. In an exemplary embodiment, the second through fifth layer function as the hidden layers 102. The structure 200 also comprises a sixth layer having conductors 206a-c and which functions as the output layer 103. In an exemplary embodiment, the conductors of the 3D neural network structure 200 perform the summing function 106 shown in FIG. 1B.

The three-dimensional (3D) neural network structure 200 also comprises threshold elements (e.g., 210a) that perform the threshold function 107 shown in FIG. 1B. Thus, the combination of a conductor and the threshold elements that are coupled to the conductor form a neuron. For example, the combination of the conductor 201c and the three threshold elements (A, B, C) coupled to the conductor 201c form neuron 209 in layer 1 (input layer). The other conductors and their associated threshold functions form additional neurons. In an exemplary embodiment, the threshold elements can be implemented by any suitable material to perform the threshold function, such as a material forming a diode, a Schottky diode, and/or any material that has threshold behavior, such as NbOx or VCrOx.

The 3D neural network structure 200 also comprises synapse elements (e.g., 210b) coupled between the threshold elements and the conductors. For example, as illustrated in FIG. 2, the synapse element 210b is coupled between the threshold element 210a and the conductor 202a. In an exemplary embodiment, the synapse elements perform the weighting function (e.g., function 109). In an exemplary embodiment, the synapse elements can be implemented by any suitable material to perform the weighting function, for instance, a resistive material such as HfOx, TaOx, chalcogenide, or other type of resistive material.

In an exemplary embodiment, the synapse elements can be implemented with resistive materials, such as HfO/HfOx for example. In another embodiment, the synapse elements can be implemented using phase change materials, such as chalcogenide for example. In another embodiment, the synapse elements can be implemented using ferroelectric materials, such as ziconate titanate for example. In another embodiment, the synapse elements can be implemented using magnetic materials, such as iron, nickel, or cobalt for example. In still another embodiment, a layer of synapse elements are referred to as an ‘activation function’ layer, which can be implemented by materials with non-linear behavior or threshold behavior, such as a diode, Schottky diode, NbOx, TaOx, or VCrOx.

In an exemplary embodiment, the conductors (201, 202, 203, 204, 205, 206) of the layers (1, 2, 3, 4, 5, 6) combined with their associated threshold elements perform the functions of the neurons in each layer of the neural network structure 200. For example, the layer 1 having conductors 201a-c and associated threshold elements function as the neurons of the input layer 101. The layers 2, 3, 4, and 5 having conductors 202a-c, 203a-c, 204a-c, 205a-c and associated threshold elements function as the neurons of the hidden layer 102. The layer 6 having conductors 206a-c and associated threshold elements function as the neurons of the output layer 103. In another exemplary embodiment, the order of the threshold elements and the synapse elements 210 can be swapped or reversed.

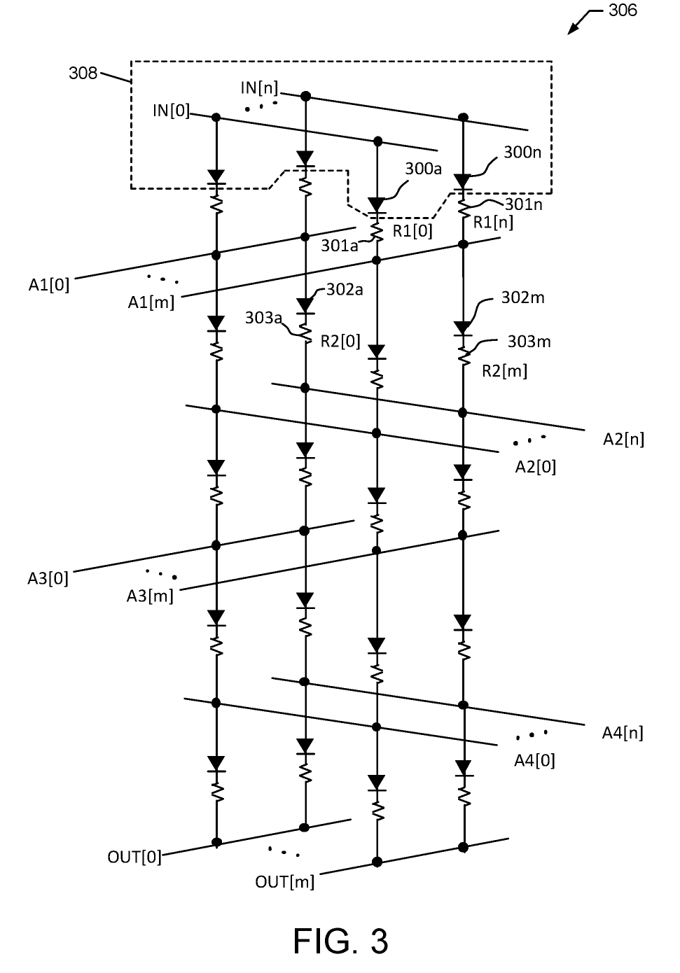

FIG. 3 shows an exemplary embodiment of a circuit 306 that is representative of the 3D neural network structure 200 shown in FIG. 2. The circuit 306 includes an input layer IN[0]-IN[n] (shown at 308), a first hidden layer A1[0]-A1[m], a second hidden layer A2[0]-A2[n], a third hidden layer A3[0]-A3[m], a fourth hidden layer A4[0]-A4[n], and an output layer OUT[0]-OUT[m]. The input layer 308 includes the input conductors IN[0]-IN[n] and associated threshold elements (e.g., diode 300), which together represent the neurons of the input layer shown in FIG. 2. Also shown in FIG. 3 are synapse elements (e.g., 301) that are coupled between the threshold elements and the conductors.

In this exemplary embodiment of the circuit 306, the threshold function of the threshold elements (e.g., 300a) is implemented using a diode material and the weighting function of the synapse elements (e.g., 301) is implemented using a variable resistive material. It will be assumed that the synapse elements that are coupled between the threshold elements 300a-n and the conductor A1[m] of the first hidden layer include resistive elements 301a to 301n that have resistance values of R1[0] to R1[n], respectively. It will be further assumed that the threshold elements 300a to 300n are implemented as diodes that have a threshold voltage (Vt). Thus, the voltage of A1[m] can be expressed as follows.

A1[m]={(IN[0]−Vt)/R1[0]+. . . +(IN[n]−Vt)/R1[n]}/(1/R1[0]+. . . +1/R1[n]) (Eq. 3)

Comparing (Eq. 3) with the neuron network equation (Eq. 1) described above with respect to FIG. 1A, the weights for each synapse element can be expressed as follows.

W1[n]=1/R1[n]×(1/R1[0]+. . . +1/R1[n]) (Eq. 4)

Moreover, the inputs IN[0]-IN[n] may be offset by adding one Vt to each input to compensate for the Vt drop of the diodes of the threshold elements connected to the input conductors. Assuming IN′[n]=(IN[n]+Vt), the equation (Eq. 3) for A1[m] can be expressed as follows.

A1[m]=IN′[0]×W1[0]+. . . +IN′[n]×W1[n] (Eq. 5)

The above equation represents the summation function of a neuron, as provided in (Eq. 2) and as described above with respect to FIG. IA. The diodes 302a to 302n perform the threshold function for the outputs from the input layer neurons that are passed to the neuron formed by conductor A1[m] and its associated threshold elements. When the voltage of A1[m] is higher than (A2[n]+Vt) (e.g., Vt of the diode 302m), the A1[m] neuron will pass voltage to A2[n], otherwise it will not pass voltage.

Similarly, the conductors A2[0]-A2[n] form neurons in the second hidden layer of the neuron network structure 200 shown in FIG. 2. For example, assuming that the resistive elements 303a to 303m have resistance values R2[0] to R2[m], respectively, the voltage of A2[n] can be expressed as follows.

A2[n]={(A1[0]−Vt)/R2[0]+. . . +(A1[m]−Vt)/R2[m]}/(1/R2[0]+. . . +1/R2[m]) (Eq. 6)

The weights for each synapse element can be expressed as follows.

W2[m]=1/{R2[m]×(1/R2[0]+. . . +1/R2[m]} (Eq. 7)

Assuming A1′[m]=(A1[m]+Vt), the equation for A2[n] becomes:

A2[n]=A1′[0]×W2[0]+. . . +A1′[m]×W2[m] (Eq. 8)

This equation is equivalent to the summation term of a neuron, as shown in equation (Eq. 2) and described above with respect to FIG. 1A. Similar analysis and results can be obtained for A3[0]-A3[m], which represents the third hidden layer, A4[0]-A4[n], which represents the fourth hidden layer, and OUT[0]-OUT[m], which represents the output layer. As a result, a multiple-layer neural network is realized by using the 3D neural network structure 200.

In an exemplary embodiment, the threshold elements, such as diode 300a, is a passive device and causes a Vt voltage drop. In order to pass a signal from the input layer to the output layer, the input voltage is preferably higher than (K+1)×Vt, where K is the number of the hidden layers. However, if the voltage is lower than (K+1)×Vt, for instance, (K×Vt), a signal can still pass through the first K layers but not to the output layer. For another example, if the input voltage is higher than (3*Vt), the voltage will pass through the first three layers, but not the fourth layer or the layers below the fourth layer. As a result, the threshold function of the fourth layer or the layers below the fourth layer fails to pass the voltage to the next layer.

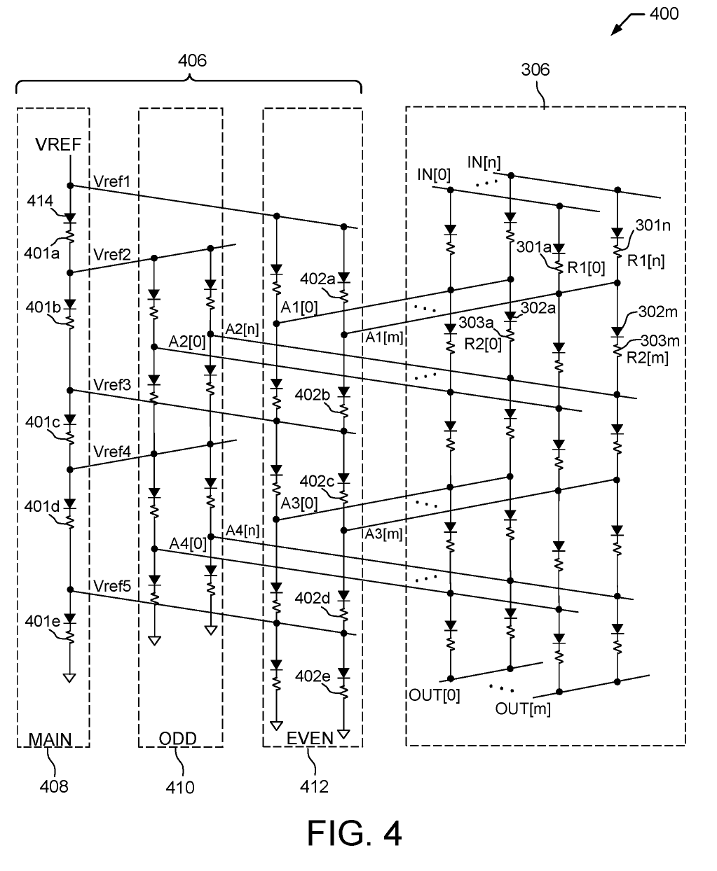

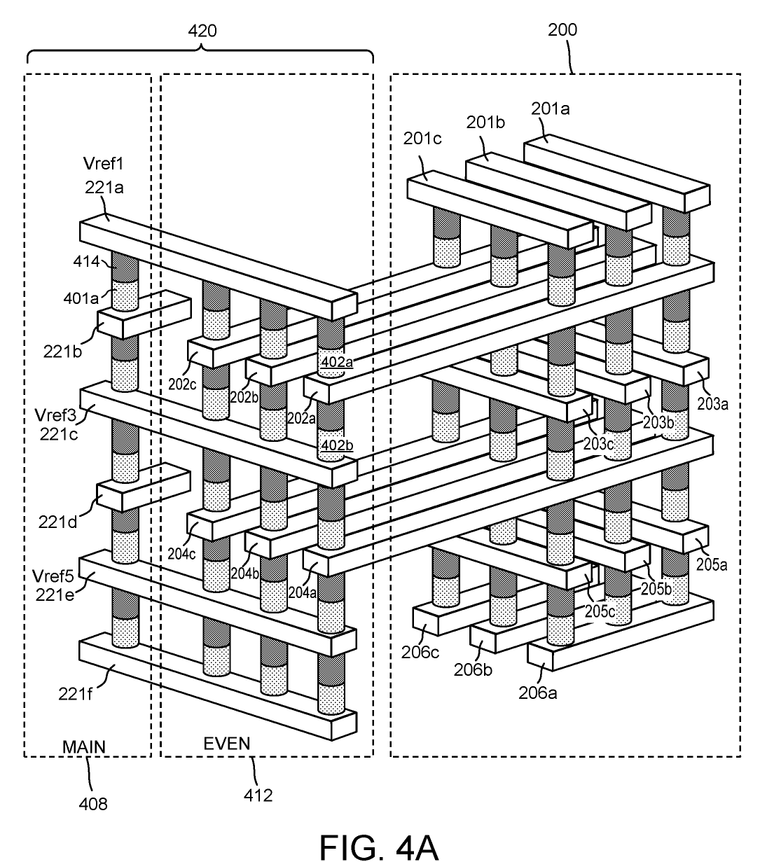

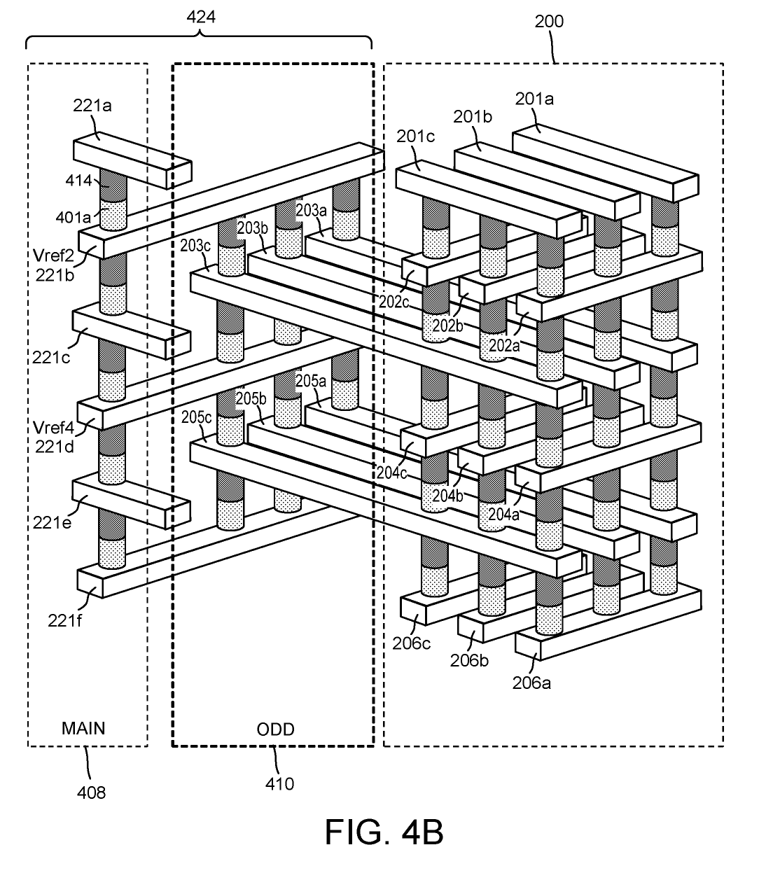

FIG. 4 shows an exemplary embodiment of a circuit 400 that is representative of the 3D neural network structure 200 shown in FIG. 2 and includes an exemplary embodiment of a reference circuit 406. The reference circuit 406 is added to the 3D neural network 300 to provide offset voltages to each hidden layer to compensate for the threshold voltage (Vt) of the threshold devices. As illustrated in FIG. 4, the reference circuit 406 includes a main reference voltage generator 408, an odd layer reference voltage generator 410, and an even layer reference voltage generator 412.

In an exemplary embodiment, the main reference voltage generator 408 comprises resistive elements 401a-e that generate the reference voltages Vref1-Vref5 from an input reference voltage VREF. The voltages Vref1-Vref5 are (5*Vt) to (1*Vt), respectively. The voltages Vref1-Vref5 are applied to the hidden layers, such as A1[0]-A1[m] and A3[0]-A3[m] through the even reference generator 412. The voltages Vref1-Vref5 are applied to the hidden layers, such as A2[0]-A2[n] and A4[0]-A4[n] through the odd reference generator 410. In an exemplary embodiment, the main 408, odd 410 and even 412 reference generators include diodes (e.g., diode 414) that are coupled between the resistive elements (e.g., 401a and 401b).

As illustrated in FIG. 4, the conductors of the first hidden layer, A1[0]-A1[m] are biased to (4*Vt) by Vref1. For example, Vref1 flows through resistive elements (e.g., 402a) of the even reference generator 412 to bias A1[0]-A1[m]. If the inputs IN[0]-IN[n] are higher than (5*Vt), such as (5*Vt+dV), the input voltages will pass the voltage dV through the threshold elements associated with IN[0]-IN[n] and pass to A1[0]-A1[m], otherwise the input voltages will not pass to A1[0]-A1[m]. Similarly, the second hidden layer, A2[0]-A2[n] are biased to (3*Vt) by Vref2. If the first hidden layer A1[0]-A1[m] are higher than (4*Vt), voltage will pass to A2[0]-A2[n], otherwise voltage will not pass to these neurons. The remaining layers are biased in the same way by Vref3, Vref4, and Vref5. Thus, the reference circuit 406 assures that the threshold functions of each layer are performed properly.

The bias threshold of each layer may be set by adjusting the resistance of the resistive elements on the corresponding odd or even reference generator. For example, for layers two and four, the resistive elements 402a to 402e as set to generate the appropriate bias levels. For example, for A1[m], if the sum of the current flowing from the inputs IN[0]-IN[n] to A1 [m] is lower than the current flowing through the resistive element 402b, the current will flow to Vref3 through the resistor 402b, and therefore A1[m] will stay at (4*Vt). If the current flowing from the inputs IN[0]-IN[n] to A1[m] is higher than the current flowing through the resistor 402b, A1[m] will be charged up to higher than (4*Vt) and start to pass current to the next layer A2[0]-A2[n]. Therefore, by adjusting the resistance of the resistive elements on the odd and even reference generators, the threshold of each layer may be adjustable.

Also notice, the resistance levels of 401a to 401e of the main reference column may be much lower than that of the odd or even reference generators. Therefore, the current flowing from A1[m] to Vref3 through the resistor 402b will be discharged by the main reference column's resistors 401c to 401e. Thus, Vref3 may be maintained at (3*Vt) to provide correct bias to the layer A3[0]-A3[m]. Otherwise, if A1[m] is charged up higher by the input currents, it may affect the voltage level of Vref3, and then affect the voltage of A3[0]-A3[m].

FIG. 4A shows an exemplary embodiment of the 3D neural network structure 200 and a biasing structure 420. The biasing structure 420 implements the main reference voltage generator 408 and the even layer reference voltage generator 412.

During operation of the network structure shown in FIG. 4A, Vref1 is applied to conductor 221a. A ground signal is applied to conductor 221f. The inputs IN[0]-IN[2] are applied to neurons 201a-c. The outputs OUT[0]-OUT[2] are provided at neurons 206a-c. The main reference voltage generator 408 generates the voltage Vref3 on conductor 221c and voltage Vref5 on conductor 221e to feed to the even layer reference voltage generator 412, which then generates the bias voltages to the neurons 202a-c and 204a-c.

FIG. 4B shows an exemplary embodiment of a 3D neural network structure that includes the 3D neural network structure 200 and a biasing structure 424 that implements the main reference voltage generator 408 and the odd layer reference voltage generator 410.

During operation of the network structure shown in FIG. 4B, Vref1 is applied to conductor 221a. A ground signal is applied to conductor 221f. The inputs IN[0]-IN[2] are applied to neurons 201a-c. The outputs OUT[0]-OUT[2] are provided at neurons 206a-c. The main reference voltage generator 408 generates the voltage Vref2 for on the conductor 221b and the voltage Vref4 on the conductor 221d to feed to the even odd reference voltage generator 410, which then generates the bias voltages to the neurons 203a-c and 205a-c.

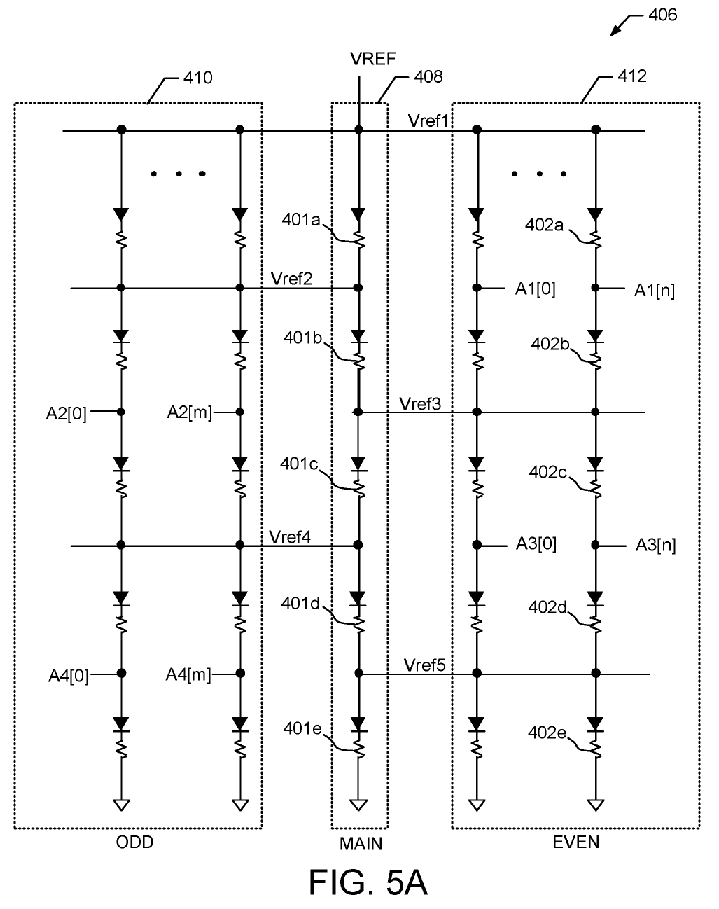

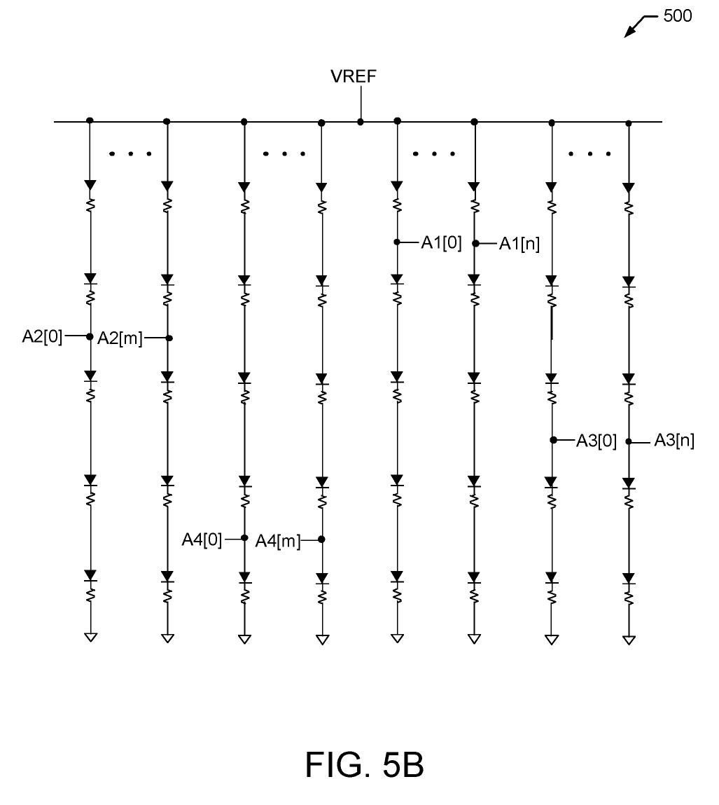

FIG. 5A shows a detailed exemplary embodiment of the reference circuit 406 shown in FIG. 4. For example, as illustrated in FIG. 5A, the main reference generator 408 comprises resistors 401a to 401e. The odd 410 and even 412 reference generators are also shown. For example, the even reference generator 412 comprises resistors 402a to 402e as shown.

FIG. 5B shows a detailed exemplary embodiment of a reference circuit 500 that is suitable for use as the reference circuit 406 shown in FIG. 4. In this embodiment, each neuron, such as neurons A1[0]-A1[n], A2[0]-A2[m], A3[0]-A3[n], and A4[0]-A4[m], has its own reference column. Thus, the current flowing from the previous layer will not affect the reference voltage of the next layer. For example, if A1[n] is charged up by the previous layer to a voltage higher than (4*Vt), it will not affect any other neuron.

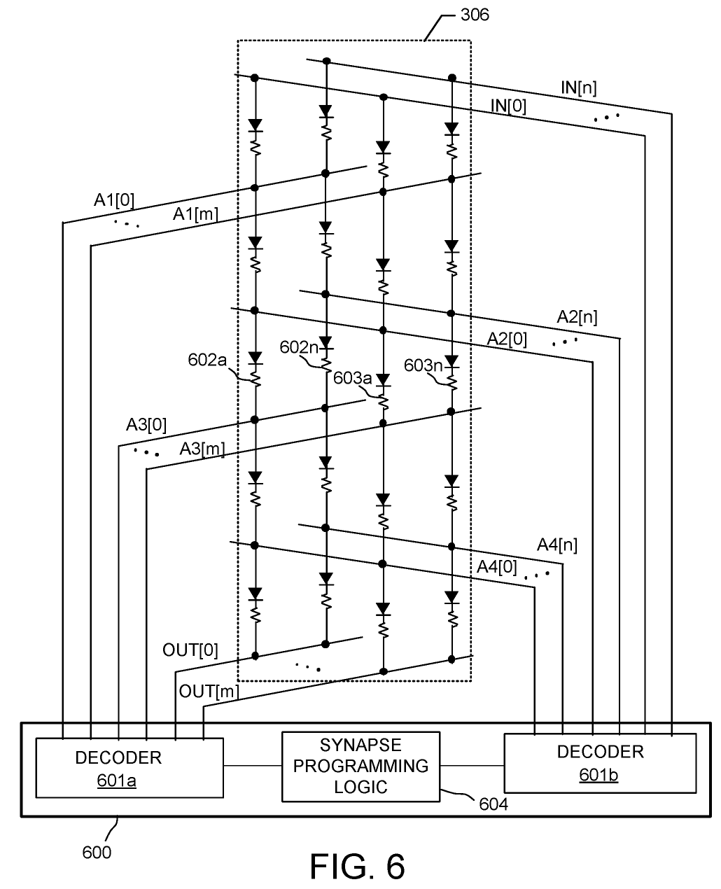

FIG. 6 shows an exemplary embodiment of a programming circuit 600 that programs the synapse elements of an exemplary embodiment of a 3D neural network structure disclosed herein. For example, the programming circuit 600 is suitable to program the synapse elements of the 3D neural network structure 200 shown in FIG. 3. For example, referring to FIG. 3, each layer of the neural network structure 200, such as neurons IN[0]-IN[n], A1[0]-A1[n], . . . , A4[0]-A4[n], and OUT[0]-OUT[m] are connected to decoder circuits 601a and 601b of the programming circuit 600. The programming circuit 600 also comprises synapse programming logic 604. In an exemplary embodiment, the synapse programming logic 604 comprises at least one of a CPU, processor, state machine, programmable logic, discrete logic, memory, registers, hardware circuitry, and/or any other suitable logic. In an exemplary embodiment, the decoders 601a-b comprise at least one of a CPU, processor, state machine, programmable logic, discrete logic, memory, registers, hardware circuitry, and/or any other suitable logic.

During a synapse programming operation, the synapse programming logic 604 determines a synapse element to be programmed. The synapse programming logic 604 controls the decoder circuits 601a and 601b to apply proper bias conditions to program selected synapse element. For example, if the synapse element 602a is selected to be programmed. The decoder circuits 601a and 601b apply the proper bias conditions to neurons A2[0] and A3[0] to program the synapse element 602a to a selected resistive value. The same process can be used to program any synapse element of the 3D neural network structure 200.

During normal operation, the decoder circuits 601a and 601b are disabled to float their outputs such that the hidden layers may be biased by the reference circuit 406 as shown in FIG. 4 to perform the neural network's programmed function.

### Partitioning of the 3D Neural Network Array

In an exemplary embodiment, the 3D neural network can be programmed to freely partition the 3D neural network array into any number of neural network groups. Each group may contain any number of layers, and each layer may contain any number of neurons and synapses. The multiple neural network groups may be used for different functions or tasks. For example, one group may be used to recognize hand-written characters and another group may be used to recognize voice.

Referring again to FIG. 6, in an example of how the number of the layers can be partitioned will now be described. The original 3D array includes one input layer IN[0]-IN[n], four hidden layers A1[0]-A1[m], A2[0]-A2[n], A3[0]-A3[m], and A4[0]-A4[n], and one output layer OUT[0]-OUT[m]. This array may be partitioned into multiple groups by programing the synapse (resistive) elements of any of the layers into a high impedance state. For example, in an exemplary embodiment, the resistive elements 602a to 602n and 603a to 603n are all programmed to a high impedance state. This vertically separates the 3D array into two groups (e.g., upper group and lower group). The decoder may use the layer A2[0]-A2[n] as the output layer of the top group, and the layer A3[0]-A3[m] as the input layer of the bottom group. Thus, the array may be partitioned to any number of vertical groups.

Moreover, the number of the synapse of each layer may be freely configured by programming unwanted synapse elements to a high-impedance state. For example, the resistive elements 602a to 603a may be programmed to a high-impedance state to disable the output of the neuron A2[0]. For another example, the resistive elements 602a to 602n may be programmed to a high impedance state to disable the inputs to the neuron A3[0].

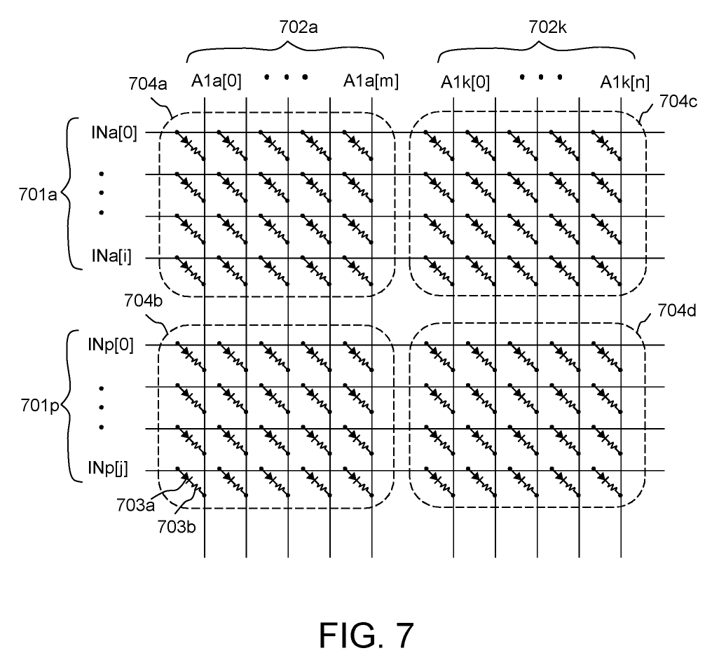

FIG. 7 shows another exemplary embodiment where the layers of the 3D neural network are partitioned into two or more groups. For example, FIG. 7 shows a top view of two layers, such as the input layer and the first hidden layer. The input layer may be partitioned into multiple groups 701a and 701p. Each section may contain a different number of inputs, for example, the group 701a comprises inputs INa[0]-INa[i] and the group 701p comprises inputs INp[0]-INp[j].

Similarly, the first hidden layer may be partitioned into multiple groups 702a to 702k. Each section may contain a different number of neurons, for example, group 702a comprises A1a[0]-A1a[m] and group 702k comprises A1k[0]-A1k[n]. This partitions the neural networks into multiple groups such as 704a to 704d, where 703a is a threshold element and 703b is a resistive element. If multiple groups share the same layer, when one group is selected to perform operations, the unselected groups are disabled to avoid disturbing the selected group. For example, if the group 704a is selected, the inputs 701a and the hidden layer's neurons 702a will be used. The unselected inputs 701p and unselected hidden layer's neurons 702k may be disabled by applying reverse bias conditions to the inputs 701a and neurons 702k to turn off the threshold elements. In this way, the unselected groups will not affect the function of the selected group.

It should also be noted that the partitioning functions described above are field-programmable and re-configurable. As a result, the various embodiments of the 3D high-density neural network provide ultra-high flexibility.

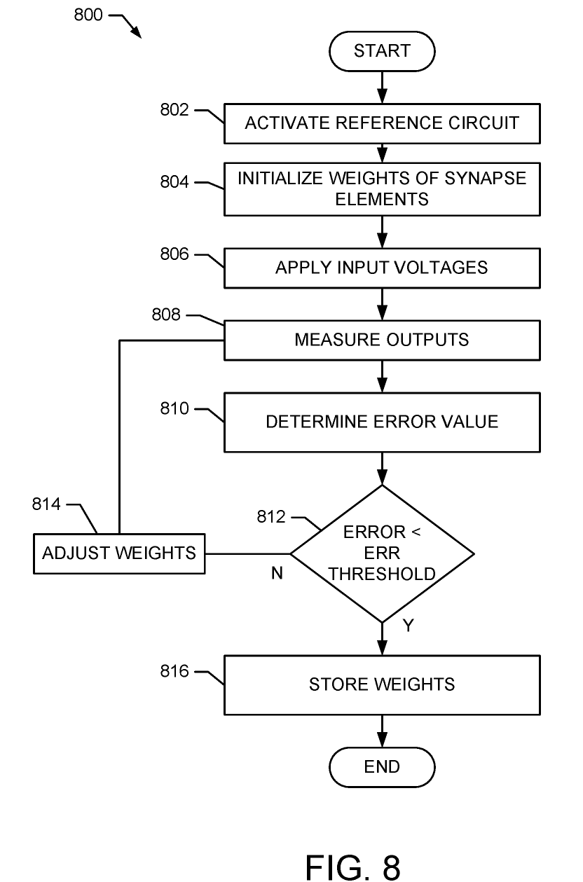

FIG. 8 shows an exemplary embodiment of method 800 for programming a 3D neural network structure. For example, the method is suitable for use to form the 3D array device shown in FIGS. 5A-H.

At block 802, a reference circuit is activated. For example, the reference circuit 406 shown in FIG. 4 is activated to provide reference voltages to the 3D neural network structure.

At block 804, the weights of the synapse elements are initialized. For example, the programming logic 604 operates to control the decoders 601a-b to initialize each synapse of the 3D neural network structure to a particular resistance value.

At block 806, input voltages are applied. For example, programming logic 604 operates to control the decoders 601a-b to apply selected input voltages to the inputs of the 3D neural network structure.

At block 808, output voltages are measured. For example, programming logic 604 operates to control the decoders 601a-b to receive and measure the output voltages the 3D neural network structure.

At block 810, an error value is computed. For example, programming logic 604 operates to compute an error value by controlling the decoders 601a-b to receive and measure the output voltages. The programming logic 604 then takes a difference between the output voltages and the desired output voltages to determine an error value.

At block 812, a determination is made as to whether the error value is less than an error threshold. For example, programming logic 604 operates compare the error value to the error threshold to determine if the error value is less than the error threshold. If the error value is not less than the error threshold, the method proceeds to block 814. If the error value is less than the error threshold, the method proceeds to block 816.

At block 814, the weights associated with one or more synapse elements are adjusted to reduce the error value. In an exemplary embodiment, programming logic 604 operates to implement a back-propagation algorithm to determine selected synapse elements to adjust and to determine how much to adjust those selected elements. Then the programming logic 604 operates to control the decoders 601a-b to set the selected synapse elements and program those elements to the appropriate weights as described with reference to FIG. 6. The method then proceeds to block 808 to determine a new output value based on the newly configured synapse weights.

At block 816, the weights of the synapse elements of the 3D neural network structure are stored. For example, the programming logic 604 operates to store the weights that have resulted in the error value being less than the error threshold. When the 3D neural network structure is to be operated to perform the desired function, the programming logic 604 retrieves the stored weights from memory and sets the synapse elements to those weight values to configured the 3D neural network structure to perform the selected function.

Thus, the method 800 operates for programming a 3D neural network structure. It should be noted that the method 800 is exemplary and that the disclosed operations may be combined, rearranged, added to, deleted, and/or modified within the scope of the embodiments.

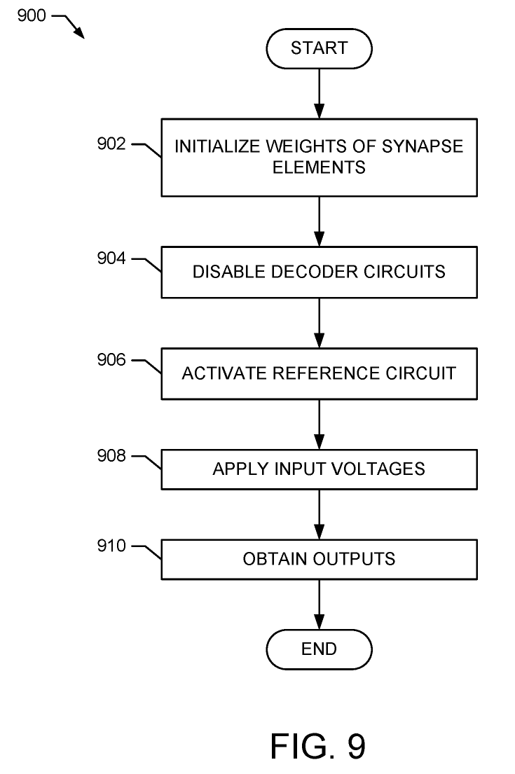

FIG. 9 shows an exemplary embodiment of method 900 for operating a 3D neural network structure. For example, the method is suitable for use to operate the 3D array neural network structure shown in FIGS. 4A-B.

At block 902, the weights of the synapse elements are initialized. For example, the programming logic 604 operates to control the decoders 601a-b to initialize each synapse of the 3D neural network structure to a particular resistance value. For example, the weight values may be stored in a memory at the programming logic 604. These weight values are retrieved and used to by the programming logic 604 to program the weights for each synapse element.

At block 904, the decoders circuits are disabled. For example, the decoders 601a-b are disabled and have no effect on the operation of the 3D neural network structure shown in FIGS. 4A-B.

At block 906, a reference circuit is activated. For example, the reference circuit 406 shown in FIG. 4 is activated to provide reference voltages to the 3D neural network structure shown in FIGS. 4A-B.

At block 908, input voltages are applied. For example, the input voltages are applied to the neurons of the input layer. The input voltages then flow through the layers of the 3D neural network structure based on the weights of the synapse elements and the summing performed at each neuron.

At block 910, an output of the 3D neural network structure is obtained at the output layer.

Thus, the method 900 provides a method for operating a 3D neural network structure. It should be noted that the method 900 is exemplary and that the disclosed operations may be combined, rearranged, added to, deleted, and/or modified within the scope of the embodiments.

While exemplary embodiments of the present invention have been shown and described, it will be obvious to those with ordinary skills in the art that based upon the teachings herein, changes and modifications may be made without departing from the exemplary embodiments and their broader aspects. Therefore, the appended claims are intended to encompass within their scope all such changes and modifications as are within the true spirit and scope of the exemplary embodiments of the present invention.

What is claimed is:

1. An apparatus, comprising:
a three-dimensional (3D) structure having a plurality of layers forming a neural network, wherein each layer comprises one or more conductors forming neurons with each neuron having neuron inputs and neuron outputs; and
synapse elements coupled between the neurons outputs and the neuron inputs of neurons in adjacent layers, wherein each synapse element comprises a material that applies a selected weight to signals passing between neurons connected to that synapse element.

2. The apparatus of claim 1, wherein the plurality of layers forms an input layer, one or more hidden layers, and an output layer.

3. The apparatus of claim 1, wherein the conductor of each neuron forms one or more neuron inputs.

4. The apparatus of claim 1, wherein each neuron output comprises a threshold material coupled between the conductor and a synapse element of a neuron in an adjacent layer, wherein the threshold material performs a threshold function.

5. The apparatus of claim 4, wherein the threshold material comprises a material selected from a set of materials comprising diode material, Schottky diode material, NbOx material, TaOx material or VCrOx material.

6. The apparatus of claim 1, wherein the material of each synapse element is programmable to provide a plurality of selectable weights.

7. The apparatus of claim 6, wherein the material of each synapse element comprises a material selected from a set of materials comprising resistive material, phase change material, ferroelectric material, and magnetic material.

8. The apparatus of claim 2, further comprising a reference circuit coupled to the neurons of the one more hidden layers, wherein the reference circuit biases the neurons of the one or more hidden layers.

9. The apparatus of claim 1, further comprising a programming circuit coupled to the plurality of layers, wherein the programming circuit programs the material of each synapse element.

10. The apparatus of claim 1, wherein the plurality of layers of the three-dimensional (3D) structure are partitioned to form multiple neural networks.

11. A method for programming a three-dimensional (3D) structure having a plurality of layers forming a neural network, wherein each layer comprises one or more conductors forming neurons, and wherein synapse elements are coupled between neurons of adjacent layers, the method comprising:
applying input voltages to an input layer of the neural network;
measuring output voltages at an output layer of the neural network;
determining an error value as a function of the input voltages and the output voltages; and
adjusting weights associated with the synapse elements if the error value is greater than an error threshold.

12. The method of claim 11, further comprising applying references voltages to the neural network before applying the input voltages.

13. The method of claim 11, wherein the operation of adjusting comprises programming each synapse element to have a selected weight value.

14. The method of claim 11, wherein the operation of adjusting comprises programming each synapse element to have one of eight selectable weight values.

15. The method of claim 11, further comprising repeating the operations of applying, measuring, determining, and adjusting until the error value is less than an error threshold.

16. The method of claim 11, further comprising storing the adjusted weights.

17. A three-dimensional (3D) neural network structure, comprising:
an input layer having at least one input conductor forming an input neuron;
one or more hidden layers, each hidden layer having at least one hidden conductor forming hidden neurons;
an output layer having at least one output conductor forming an output neuron;
threshold material coupled to each of the input, hidden, and output conductors; and
synapse elements coupled between the threshold material associated with a selected layer and the conductors of an adjacent layer, wherein each synapse element comprises a material that applies a selected weight to signals passing through that synapse element.

18. The apparatus of claim 17, wherein the threshold material comprises a material selected from a set of materials comprising diode material, Schottky diode material, NbOx material, TaOx material or VCrOx material.

19. The apparatus of claim 17, wherein the material of each synapse element comprises a material selected from a set of materials comprising resistive material, phase change material, ferroelectric material, and magnetic material.

20. The apparatus of claim 17, further comprising a reference circuit coupled to the hidden conductors.
